(19) United States
(12) Patent Application Publication
(10) Pub. No.: US 2014/0069211 A1
(43) Pub. Date: Mar. 13, 2014

(54) TORQUE TOOL WITH DISPLAY

(71) Applicant: Eduard Wille GmbH & Co. KG, (US)

(72) Inventors: Michael Backhaus, Dortmund (DE); Siegfried Herbold, Wuppertal (DE); Christof Petig, Wuppertal (DE); Nikolay Stoilov, Wuppertal (DE); Joachim Wilhelm, Wuppertal (DE)

(73) Assignee: Eduard Wille GmbH & Co. KG, Wuppertal (DE)

(21) Appl. No.: 13/780,097

(22) Filed: Feb. 28, 2013

(30) Foreign Application Priority Data
Mar. 1, 2012 (DE) 20 2012 100 712.6

(51) Int. Cl. B25B 23/142

(52) U.S. Cl. CPC B25B 23/1427
USPC 73/862.23

(57) ABSTRACT

A torque tool for measuring and/or applying a torque, consists of a shaft-like housing with a handle at one end, wherein a measuring device is provided in the housing for detecting the torque. A connecting member is provided at the other end of the housing which transmits the torque to a work piece. A digital display indicates the applied torque or a preset torque. The display is formed as an electronic OLED display.

### RELATED APPLICATIONS

This application claims priority of German Utility Model Application No. 20 2012 100 712.6 filed by the inventors on Mar. 1, 2012, which application is hereby incorporated in its entirety by reference.

### FIELD OF THE INVENTION

This invention relates to tools in general, and more particularly it relates to the torque tools for measuring and/or applying of a torque.

### BACKGROUND OF THE INVENTION

The screw connection is the most commonly used connection in mechanical engineering. Such connections can only become effective by using appropriate installation tools. These appropriate installation tools include torque tools like those mentioned in the beginning. Torque tools are needed in order to exert a certain torque to a work piece. Known torque tools are, for example, torque wrenches or torque screwdrivers.

When using hand-held tools the torque to be transmitted depends on the physical condition of the user as well as his subjective force-sensing. Torque tools are used in order to load a screw with a large biasing force which is in the elastic range of the screw, or to load the screw with only a small biasing force. The use of new construction materials such as magnesium, aluminum or plastic, especially for lightweight construction in the automotive and aircraft industries increases both the demand as well as the requirements for torque tools. These new materials in particular increase the number of sensitive screw connections. The lower tensile strength of lightweight materials compared to steel materials results in damaging the screw thread when overstraining the screw connection which would make these expensive components unusable.

For example, a given torque can be exerted on connecting elements, such as screws or bolts by using a torque wrench. For this purpose torque wrenches comprise a wrench lever with a handle and a wrench head. Often a coupling formed as a square pin is provided at the wrench head for holding tools. Various socket tools for screwing nuts and bolts can be plugged on the square pin. A force applied by a user to the handle in the direction of actuation is transmitted to the wrench head by the wrench lever and generates a torque on a screw or nut by the socket tool. For measuring the applied torque and, if necessary, the angle of rotation the torque wrench comprises a measuring device. The measured torque can be continuously displayed or the reaching of a preset torque can be signaled by other devices.

Torque wrenches with digital torque displays are state of the art in view of DE 20 2008 005 705 U1. A major drawback of such digital displays is the fact that depending on the angle of view to the display of the torque wrench the display is no longer clearly visible, so that it is difficult for a user to recognize whether a certain torque has been reached. DE 20 2007 018 043 U1 describes a torque wrench, in which the displayed digits are highlighted with an illuminated display, wherein a specific torque range is signaled to the user by color. The disadvantage in doing so is that the colored illumination of the display often is only visible for the user of the torque tool from a certain viewing direction. Especially when working in places with limited visibility the readability becomes difficult.

Therefore, from the utility model DE 20 2009 002 124 U1 a torque wrench with a display unit is known, which is arranged on the tool shaft of the torque wrench. At least two different optical signals are displayable by the display unit, wherein the display unit annularly encircles the tool shaft. In doing so an optical signal for detecting the applied torque is emitted at the circumference of the display unit in all radial directions, so that a user can recognize without a direct view to the display module in which torque range a currently applied torque belongs. For generating the optical signals at least one light emitter, for example in the form of light-emitting diodes (LEDs) is provided in the display unit. The optical signals can be carried out in accordance with the traffic light principle wherein a different color is assigned to each torque range. For example, the range below the preset torque can be signaled by yellow light, within a tolerance range of the preset torque by green light, and the exceeding of the preset maximum torque can be signaled by a red light. It is also possible to vary the brightness of the optical signals so that the maximum intensity is displayed after exceeding the preset maximum torque. Moreover, it is possible to vary the flash rate of the optical signals, so that the respective torque or angle progress is indicated by a slow flashing frequency up to a continuous light.

Further on, organic light emitting diodes (OLEDs) are known. These are luminous thin film components made of organic semiconducting materials. The OLED differs from the inorganic light-emitting diodes (LED) in that the current density and the luminance is lower and no single crystal materials are required. One benefit of OLED displays over traditional liquid crystal displays is the very high contrast, since they require no backlight. Liquid crystal displays operate only with colored filters. OLED displays emit colored light by themselves, which leads to a better color reproduction.

The document DE 112009001882 T5 describes, for example, a display with an organic light emitting diode (OLED display) having an active matrix. A typical OLED device comprises two layers of organic material, of which one layer is of a light-emitting material, such as a light emitting polymer (LEP), an oligomer or a light-emitting material with a low molecular weight, while the other one is a layer of a hole-conducting material, such as a polythiophene derivate or a polyanilin derivate. Organic LEDs can be deposited on a substrate in a matrix of pixels to form a display with single-colored or multi-colored pixels. A multicolor display can be constructed by using groups of red-, green- and blue-emitting sub-pixels. So-called displays with an active matrix contain a memory element, typically a storage capacitor and a transistor, which are assigned to each pixel (whereas displays with passive matrix do not have such a storage element and are repeatedly scanned to provide the impression of a steady image). It is common to provide a current programmed control for an OLED, because the brightness of an OLED is determined by the current flowing through the device, wherein the current determines the number of photons which are generated.

The known torque tools, as described, for example, in DE 20 2009 002 124U1, have the disadvantage that reading the display is only possible from a clearly limited view angle. This is because LCD displays have a large structural form compared with torque tools. The annular display unit also has the disadvantage that it is very large, and that it can be a disturbing factor in the use of the torque tool, especially in confined space. A further disadvantage of the known torque tools is that the energy consumption of the display is very high.

### SUMMARY OF THE INVENTION

One aspect of the invention relates to a torque tool for measuring and/or applying of a torque, comprising a shaft-like housing with a handle at one end, wherein a measuring device is provided in the housing for detecting the torque, a connecting member is provided at the other end of the housing which transmits the torque to a work piece, and a digital display indicating the applied torque or a preset torque respectively.

Another aspect of the invention relates to a torque tool for measuring and/or applying a torque which is formed as an electronic OLED display.

A further aspect and object of the invention is to avoid the disadvantages of the prior art and to provide a compact display for torque tools, which operates essentially based on a low energy consumption.

Advantages and embodiments of the invention arise from the subject matter of the claims supported by the specification and drawings.

### BRIEF DESCRIPTION OF THE DRAWINGS

FIG. 1 is a perspective view of a torque tool with OLED display according to the present invention;

FIG. 2 is a schematic top view of the torque tool with OLED display according to the present invention;

FIG. 3 is a schematic side view of the torque tool according to the present invention; and

FIG. 4 is a schematic bottom view of the torque tool according to the present invention.

### DETAILED DESCRIPTION OF THE INVENTION

The invention is based on using an electronic OLED display with torque tools instead of the LCD display having relatively high energy consumption. OLED displays are distinguished not only by their compactness, but also due to the extremely low power consumption. OLED displays are driven directly to illumination. Therefore, they require no backlight, which shines through a colored driven filter. OLED displays are much more efficient, making OLED displays use less power. Further on, by using the OLED display technology the viewing angle is expanded up to 170°. Surprisingly, such compact OLED displays can also be used with torque tools. Thus, the torque tools are much more compact. Because of the lower energy consumption, correspondingly smaller accumulators can be used, for example, which also affects the compactness of the whole torque tool. Thus, the torque tool can be well used in tight spaces. If necessary, the useful life of the accumulators can be extended simply because of the lower energy consumption of the OLED display.

One embodiment of the invention provides the electronic OLED display on the shaft-like housing of the inventive torque tool for measuring and/or applying a torque. The shaft-like housing offers sufficient space for incorporating or mounting the OLED display. Further on, the OLED can be easily read by a user in this position. Thereby, a further advantageous aspect of the invention is to provide the electronic display OLED detachable on the shaft-like housing. In doing so, the OLED display can be exchanged at any time. If necessary, other displays with, for example, other properties or functions can be attached to the shaft-like housing.

Since the viewing angle is also limited in the OLED display, in a preferred embodiment of the torque tool according to the invention, an optical signal transmitter is provided which is actuated by the torque applied to the torque tool, wherein the signal transmitter emits an optical signal changing in correspondence with the change of the torque. Hence, this measure is suitable to extend the angle for recognizing the applied torque by the user by arranging the signal transmitters accordingly. They are positioned so that they can be seen from a different angle by a user. For example, the optical signal transmitter can change its color, so that the user of the torque tool always knows in which range he is operating in the moment. Thus, for example, the spectrum can pass through from yellow over green to red, like a traffic light, wherein green means “torque is reached”. On red the torque is exceeded. Yellow can be seen as an early warning, i.e. the preset torque is almost reached. Flashing of the optical signal transmitter, for example, may be an error message.

Preferably, the optical signal transmitter of the inventive torque tool is adapted as a light source, which emits a light intensity and/or a flashing frequency changing with the change of the torque. In alternative to or in combination with the changing color spectrum, these measures also serve for visually signaling to the user of the torque tool how far the torque is applied.

In another embodiment of the torque tool according to the invention an acoustic signal generator is provided, which emits an acoustic signal changing in correspondence with the change of the torque. This measure also serves to inform the user about the applied torque at any time. Thus, for example information about the torque can be transmitted when the display or the optical signals are not visible. The acoustic signal can be, for example, a sequence of sounds, which will increase speed. Upon reaching the preset torque, for example, a continuous tone is generated. Accordingly and also for example, the pitch can be varied on a changing torque.

To process the detected torque values in a suitable manner, a processor-controlled measuring and control unit for processing of the detected and digitized torque values and/or for controlling of the OLED display or the signal generators of the torque tool is provided in a further preferred embodiment of torque tool according to the invention. Typically, the detected torque values are initially present as an analog signal and must be digitized by means of an analog-to-digital converter. The digitized values are processed with the measuring and control unit, stored in a digital memory if necessary, and displayed on the OLED display. For this purpose the measuring and control unit controls the OLED display in an appropriate manner.

A further embodiment of the invention provides an interface for transmitting data, such as measurement and tool data. By the interface the data obtained during the measurement can be transmitted to, for example, a central processing unit for logging and documenting the torque values. This serves in particular for monitoring and controlling of the measurements. On the other hand, data can also be transmitted to the torque tool via the interface, such as the torque to be preset for the measurement.

Preferably the torque tool is a torque wrench or a torque screwdriver. These torque tools are particularly well suited for the measurement of torques.

In a preferred embodiment of the inventive torque tool a measuring device is provided for detecting an angle of rotation. This measure serves to determine the angle of rotation in addition to the torque. The angle of rotation is also a frequently used measure for the tightening of a screw.

In a particular embodiment of the torque tool for measuring and/or applying a torque the optical signal transmitter is provided projecting from the housing and/or in a suitable recess of the housing. In doing so the signal generator is visible over a larger angle range. The recess has to have a sufficient size in order for the optical signal transmitter to be optimally visible from all sides. If necessary, the recess may also be coated with a reflective layer. In this case, the optical signal transmitter must not be visible directly. The measure allows the user of the torque tool to have a good view for recognizing the respective applied torque at any time.

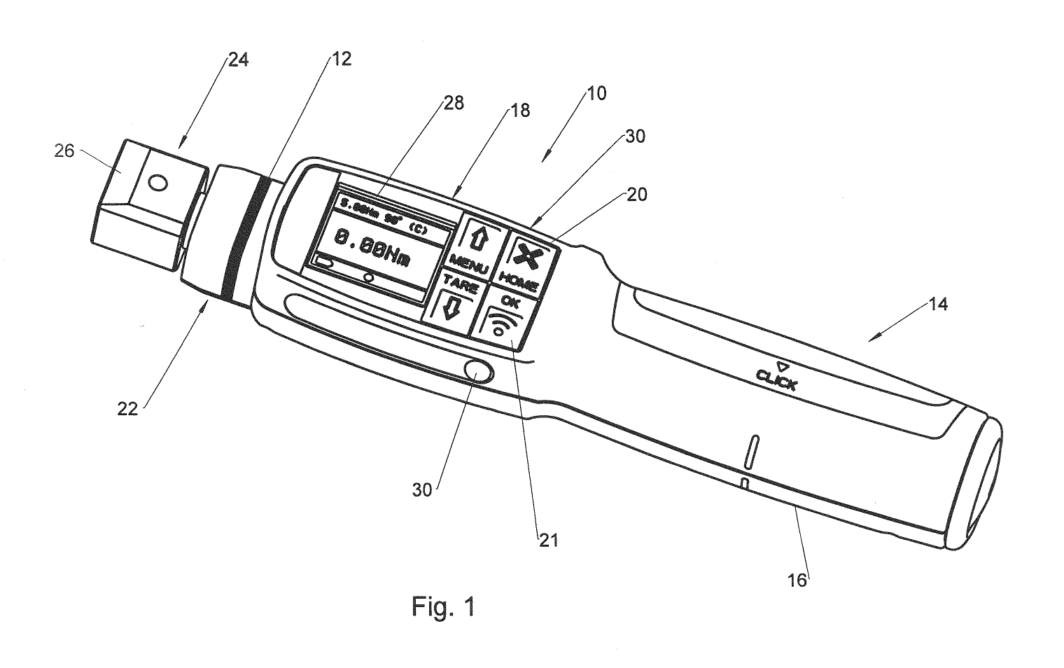

Referring now to FIG. 1, wherein numeral 10 denotes a torque tool for measuring and/or applying a torque according to the present invention. The torque tool 10 is shown in a perspective principle sketch. The torque tool 10 comprises a shaft-like housing 12 with a handle 16 provided on one end 14 of the housing. A non-visible measuring device for detecting a torque is arranged in the housing 12.

The measuring device comprises a processor-controlled measuring and control unit 18. The measuring and control unit 18 processes detected and digitized torque values. Besides measurement and control programs, measurement data can also be stored in a digital memory of the measuring and control unit 18. A control panel 20 is provided as part of the measuring and control unit 18 for setting up and operating the torque tool 10. In this embodiment, the control panel 20 is designed with switch-keys 21. In principle, a touch-sensitive display (touch screen) is also possible, which displays the corresponding buttons to choose.

The required power supply for the electronic components is provided to the torque tool 10 by accumulators, which are arranged in the handle 16, and therefore are not visible. At the other end 22 of the shaft-like housing 12 a connecting member 24 is provided. In the present embodiment this is a square 26, on which a suitable socket tool can be attached for transmitting the torque to a work piece. The respectively applied torques are sampled at appropriate and adjustable time intervals and digitized by the torque tool 10. The torque value detected and processed in the measuring and control unit 18 is finally displayed on a digital display 28. For this purpose, the measuring and control unit 18 controls the display 28 in a suitable manner. The display 28 is designed as an electronic OLED display, which is provided on the shaft-shaped housing 12. The determined torque is displayed graphically or numerically on the display 28. The OLED display 28 is provided detachably and can be removed if necessary.

Optical signal transmitters 30 of the torque tool 10 are provided laterally to the OLED display 28. In the present embodiment, these are also OLEDs. Basically, inorganic LEDs can also be used. The signal transmitters 30 are arranged so that the angle for recognizing the applied torque by a user is extended. Thereto, they are adapted to project a little. For example, the signal transmitter 30 can change its color, so that the user of the torque tool 10 always knows in which range he is operating in the moment. Thus, for example, the spectrum can pass through from yellow to green to red, like a traffic light, wherein green means that the preset torque is reached. Red means “exceeded torque”. Yellow can be seen as an early warning, i.e. the preset torque is almost reached. Flashing of the optical signal transmitter 30, for example, may be an error message.

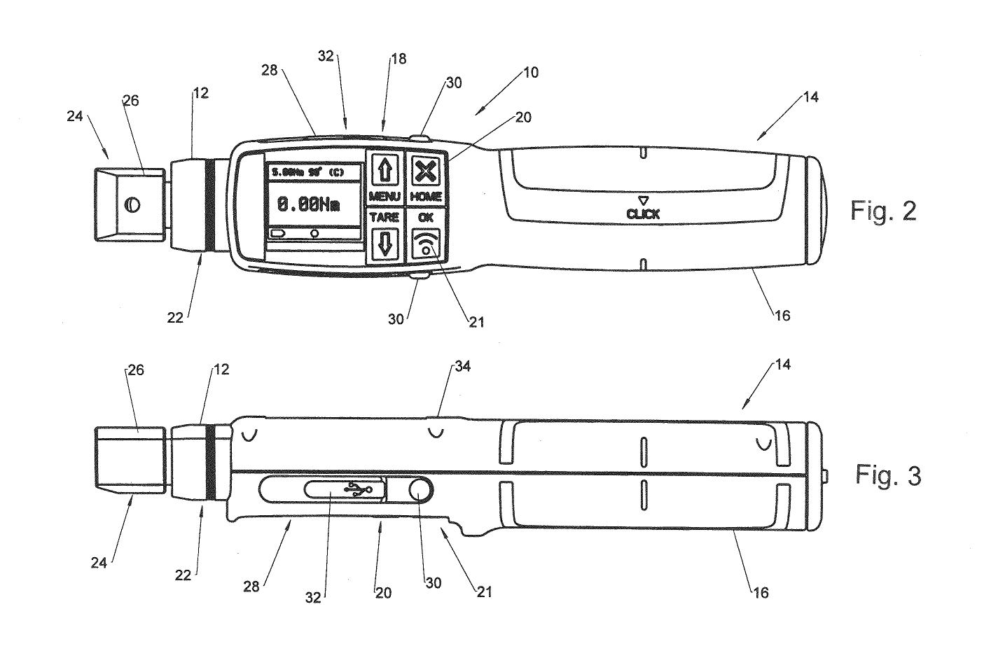

FIG. 2 shows a top view of the inventive torque tool 10 with the OLED display 28 according to FIG. 1. Therefore, same components are designated with the corresponding reference numeral. In the view of FIG. 2 it is particularly apparent that the optical signal transmitters 30 are mounted on both sides of the OLED display 28. Thereby, the optical signal transmitters 30 are projecting a little. In doing so, the user of the torque tool 10 can observe the torque practically over 360° within a certain range of tolerance.

In FIG. 3 the inventive torque tool 10, as previously discussed with reference to FIGS. 1 and 2, is shown at a side view thereof. In FIG. 3, components matching to the preceding Figures are designated by corresponding reference numerals. In this view, an interface 32 is visible. The interface 32 is adapted as a standard USB interface. In doing so a data exchange with a conventional computer can be perform in a simple manner. Generally, radio interfaces such as Bluetooth or WIFI can also be provided for data exchange. Furthermore, the accumulators can be charged via the USB interface 32.

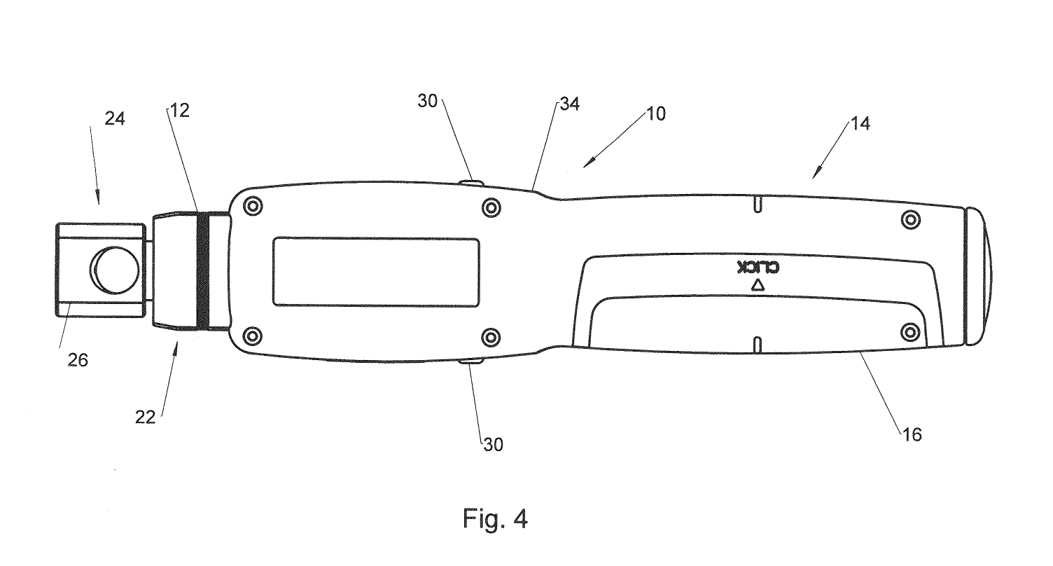

FIG. 4 shows the bottom side of the inventive torque tool 10 according to the previous FIGS. 1 to 3. As before, components according to the previous Figures are designated with corresponding reference numerals. From this view it becomes apparent that the optical signal transmitter 30 is also visible from the underside for a user of the torque tool. In doing so the torques are readable from all sides of the torque tool 10 optically and the reaching the final torque is observable. An acoustic signal generator 34 supports signaling the final torque if required. For example, the acoustic signal generator 34 emits an acoustic signal changing in correspondence with the change of the torque. For this purpose the acoustic signal generator 34 is controlled by the measuring and control unit 18. On malfunction of the torque tool an acoustic signal can also be generated by the acoustic signal generator 34.

What is claimed is:

1. A torque tool for measuring or applying a torque, comprising:
a shaft-like housing with a handle at one end, wherein a measuring device is provided in the housing for detecting said torque,
a connecting member is provided at the other end of the housing which transmits said torque to a work piece; and
a digital display indicating said applied torque or a preset torque respectively;
wherein the display is formed as an electronic OLED display.

2. A torque tool according to claim 1, wherein said electronic OLED display is provided on said shaft-like housing.

3. A torque tool according to claim 2, wherein said electronic OLED display is detachable with respect to said shaft-like housing.

4. A torque tool according to claim 1, wherein an optical signal transmitter is provided which is actuated by said torque applied to the torque tool, so that the signal transmitter emits an optical signal changing in correspondence with the change of said torque.

5. A torque tool according to claim 4, wherein said optical signal transmitter is adapted as a light source, which emits a light intensity and/or a flashing frequency changing with the change of said torque.

6. A torque tool according to claim 1, wherein an acoustic signal generator is provided which emits an acoustic signal changing in correspondence with the change of said torque.

7. A torque tool according to claim 1, wherein a processor-controlled measuring and control unit is provided for processing of the detected and digitized torque values and/or for controlling of said OLED display.

8. A torque tool according to claim 1, further comprising:
an optical signal transmitter which is actuated by said torque applied to the torque tool, wherein the optical signal transmitter emits an optical signal changing in correspondence with the change of said torque;
an acoustic signal generator which emits an acoustic signal changing in correspondence with the change of said torque; and
a processor-controlled measuring and control unit for processing of the detected and digitized torque values and for controlling of said OLED display, said optical signal generator and said acoustical signal generator.

9. A torque tool according to claim 1, wherein an interface is provided for transmitting data, such as measurement and tool data.

10. A torque tool according to claim 1, wherein said torque tool is a torque wrench or torque screwdriver.

11. A torque tool according to claim 1, wherein a measuring device is provided for detecting an angle of rotation.

12. A torque tool according to claim 4, wherein said optical signal transmitter is provided projecting from said housing and/or in a recess of said housing.
